(19) United States
(12) Patent Application Publication
(10) Pub. No.: US 2012/0197732 A1
(43) Pub. Date: Aug. 2, 2012

(54) ACTION-AWARE INTENT-BASED BEHAVIOR TARGETING

(75) Inventors: DOU SHEN, Bellevue, WA (US); JUN YAN, Beijing (CN); XIANFANG WANG, Snoqualmie, WA (US); JIAYUAN HUANG, Sammamish, WA (US); VALERI LIBORSKI, Kirkland, WA (US); YING LI, Bellevue, WA (US)

(73) Assignee: MICROSOFT CORPORATION, REDMOND, WA (US)

(21) Appl. No.: 13/017,843

(22) Filed: Jan. 31, 2011

(51) Int. Cl. G06Q 30/00; G06F 15/18; G06N 5/02

(52) U.S. Cl. 705/14.66; 706/54; 706/12

(57) ABSTRACT

Methods and computer-storage media having computer-executable instructions embodied thereon that facilitate classifying user intent with respect to an entity using intent-strength scores. A user query indicating a particular entity is received. The user's intent with respect to the particular entity is determined by assigning an intent-strength score to the user. The user's intent-strength score is determined using intent-strength scores assigned to seed patterns identified for entities in a category, as well as the received user query. In embodiments, a user's intent-strength score may be updated based on a subsequent query, or may be changed according to a function. A list of users having particular intent-strength scores for particular entities may be also be generated.

### BACKGROUND

Advertisements are typically displayed with a variety of other content when presenting a webpage to a user. Often, the advertisements presented in conjunction with webpage content are indiscreet, display advertisements, with little relation to the content of the webpage displayed. Further, such display advertisements are presented without insight into a user's particular intent with respect to the particular webpage.

In some instances, display advertisements are targeted to a particular user based on user behavior. For example, a particular user may have a history of entering queries for a particular product, and targeted display advertisements related to the user's previous queries may be displayed when viewing future webpages. Webpages use a variety of methods to determine the types of display advertisements to present to a user when presenting targeted display advertisements.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to classifying user intent using intent-strength scores and presenting intent-based behavior-targeted advertisements to users based on the classified user intent. For example, behavior-targeted advertisements are presented to a user with other content displayed on a webpage. The behavior-targeted advertisements may relate directly to the type of webpage being viewed by the user, and in some instances may be targeted to the particular user viewing the webpage based on the user's classified user intent. In some embodiments, the behavior-targeted advertisements are displayed based on a user's classified user intent. For example, behavior-targeted display advertisements may be presented to a user based on the user's assigned intent-strength score, which indicates the user's intent with respect to a particular product category. In another embodiment, the behavior-targeted display advertisements may be presented to a user based on the user's classified user intent with respect to a particular action the user intends to take.

Intent-strength scores are assigned to particular users presented with behavior-targeted advertisements. In assigning such intent-strength scores, seed patterns are identified for an entity. An entity refers to one type of item in a category, such as a type of product in a product category. In embodiments, a seed pattern includes the name of the entity and at least one additional term. Seed patterns may be expanded to include additional seed patterns for the same entity, using query log data related to the product category. Intent-strength scores are then assigned to the original identified seed patterns and the expanded additional seed patterns. The assigned intent-strength scores identify user interest with respect to the entity. In further embodiments, a corresponding intent-strength score is assigned to a user, the corresponding intent-strength score indicating the user's classified user intent with respect to the entity. The user's corresponding intent-strength score is based on user queries entered by the user, as well as the intent-strength scores assigned to the seed patterns. By generating the user's intent-strength score using user-submitted queries, the behavior-targeted advertisements presented to the user based on intent-strength scores may then be referred to as “action-aware.”

A user's intent with respect to a particular entity's category may be updated and/or “freshened” over time. As such, based on subsequent user queries entered by the user, a new intent-strength score may be assigned to the user. In another embodiment, a user's intent-strength score is changed according to a function. The function may vary according to one or more variables, including time, product characteristics, user characteristics, and other variables affecting a user's intent with respect to a particular product category.

### BRIEF DESCRIPTION OF THE DRAWINGS

Embodiments of the present invention are described in detail below with reference to the attached drawing figures, wherein:

FIG. 1 is a block diagram of an exemplary computing environment suitable for use in implementing embodiments of the present invention;

FIGS. 2-3 are flow diagrams showing methods for training a classifier for intent-strength score detection, in accordance with embodiments of the present invention;

FIG. 4 is a flow diagram showing a method for online intent detection and intent-score result generation, in accordance with an embodiment of the present invention; and

FIG. 5 is an exemplary user interface for selecting a group of users based on intent-strength scores, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are generally directed to classifying user intent with respect to a particular entity using intent-strength scores. More particularly, seed patterns associated with intent-strength scores are utilized to identify a particular user's intent-strength score with respect to a particular entity based on user queries. In embodiments, seed patterns are determined for entities in a particular category. An entity may be one type of product in a product category, and a list of entities may be generated from a variety of sources. For a particular entity and/or product, seed patterns are manually identified. The manually identified seed patterns are assigned intent-strength scores. The identified seed patterns may be then be used to generate additional seed patterns using random walk. Random walk may also be utilized to assign intent-strength scores to the additional seed patterns. The manually-identified seed patterns and the additional seed patterns may also be used to generate additional seed patterns using a machine-learned automatic classifier.

Having identified seed patterns, and corresponding intent-strength scores for the seed patterns, a user's intent with respect to a particular entity, or category of entities, may be determined. Intent-strength scores are assigned to users based on queries entered by the users and intent-strength scores assigned to seed patterns. In other words, a user-submitted query that satisfies a particular seed pattern is used to assign an intent-strength score to the user. A user-submitted query refers to a query submitted by a user in a search results webpage. In some embodiments, a user's intent-strength score may be updated over time, based on subsequent user queries and on the intent-strength scores assigned to the seed patterns. Additionally, as previously discussed, a user's intent-strength score may be changed according to a function.

Accordingly, one embodiment of the present invention is directed to one or more computer-readable media storing computer-usable instructions that, when used by one or more computing devices, causes the one or more computing devices to perform a method for classifying user intent with respect to at least one entity. The method comprises: identifying one or more seed patterns for the at least one entity, wherein the one or more seed patterns comprise one or more terms and a name for the at least one entity; expanding the one or more identified seed patterns using query log data to identify one or more additional seed patterns for the at least one entity; and assigning intent-strength scores to the one or more identified seed patterns and the one or more additional seed patterns, wherein the intent-strength scores identify a level of user interest with respect to the at least one entity.

In another embodiment, the invention is directed to one or more computer-readable media storing computer-usable instructions that, when used by one or more computing devices, causes the one or more computing devices to perform a method for classifying user intent with respect to at least one entity. The method comprises: assigning intent-strength scores to each of one or more seed patterns, wherein the one or more seed patterns were identified for the at least one entity, wherein an intent-strength score describes a user's level of interest related to the at least one entity; and assigning corresponding intent-strength scores to each of a first set of one or more users by correlating on one or more queries entered by the first set of one or more users with the intent-strength scores assigned to the one or more seed patterns.

A further embodiment of the present invention is directed to one or more computer-readable media storing computer-usable instructions that, when used by one or more computing devices, causes the one or more computing devices to perform a method for determining a user's classified user intent with respect to a particular entity. The method comprises: receiving an indication of a user query submitted by the user; and classifying the user's intent with respect to the particular entity, the classified user intent having an assigned intent-strength score, wherein the user's assigned intent-strength score is determined according to the following: (1) assigning intent-strength scores to each of one or more seed patterns, wherein the one or more seed patterns were identified for at least one entity, the at least one entity being one type of product in the particular product category; and (2) assigning a corresponding intent-strength score to the user that indicates the user's classified user intent, wherein the corresponding intent-strength score is based on the indication of a user query submitted by the user and the intent-strength scores assigned to each of the one or more seed patterns.

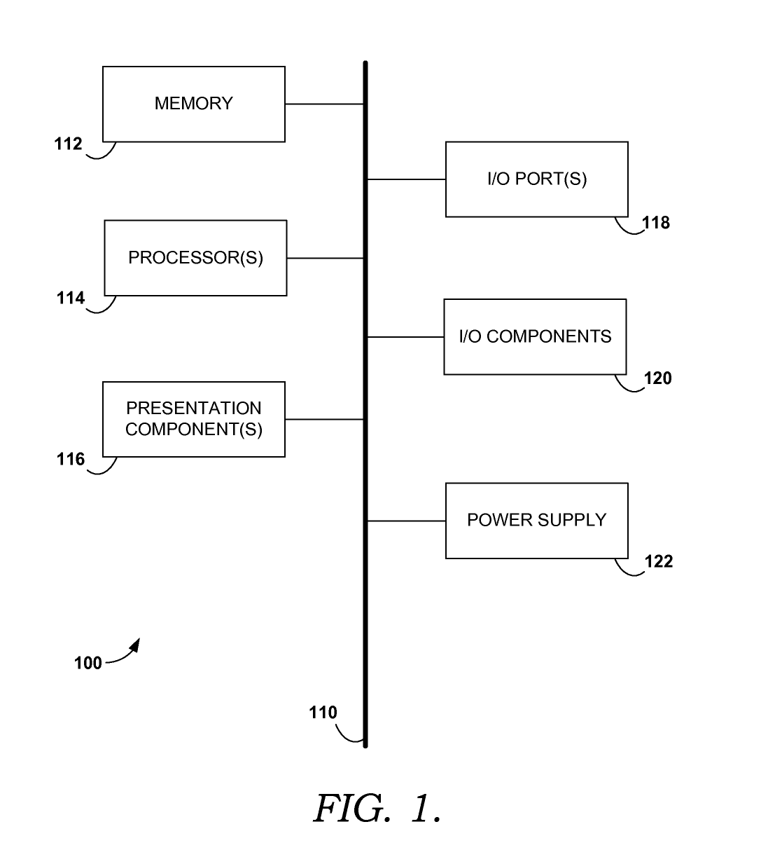

Having described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-usable instructions, including computer-executable instructions such as program modules, being executed by a computer or other machine, such as a personal data assistant or other handheld device. Generally, program modules including routines, programs, objects, components, data structures, etc., refer to code that performs particular tasks or implements particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network.

With continued reference to FIG. 1, the computing device 100 includes a bus 110 that directly or indirectly couples the following devices: a memory 112, one or more processors 114, one or more presentation components 116, input/output (I/O) ports 118, I/O components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. The inventors recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media can be any available media accessible by the computing device 100 and includes both volatile and nonvolatile media, and removable and non-removable media, implemented in any method or technology for storage of information such as computer-readable instructions, data structures, program modules or other data. Computer-readable media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 100. Combinations of any of the above are also included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, etc. The computing device 100 includes one or more processors that read data from various entities such as the memory 112 or the I/O components 120. The presentation component(s) 116 present data indications to a user or other device. Exemplary presentation components include a display device, speaker, printing component, vibrating component, etc.

The I/O ports 118 allow the computing device 100 to be logically coupled to other devices including the I/O components 120, some of which may be built in. Illustrative components include a microphone, joystick, game pad, satellite dish, scanner, printer, wireless device, etc.

As indicated previously, embodiments of the present invention are directed to classifying user intent with respect to a particular entity using intent-strength scores. A user's intent with respect to a particular entity refers to a user's intended action (or a group of users' intended actions) with respect to an entity or a group of entities, such as one or more products in a product category. For example, a user's intent with respect to the product category of digital cameras may be that the user is interested in purchasing a camera. As such, the user's intended action of purchasing a digital camera may also be associated with an identifiable intent-strength score. In embodiments, if it is determined that the user strongly desires to purchase a digital camera, then the user's intent-strength score with respect to the intended action of purchasing a digital camera may be relatively high, as compared to the intent-strength scores of other users who do not intend to purchase a digital camera.

Determining a user's level of interest with respect to the particular intended action (i.e. purchasing a digital camera) is determined using seed patterns. Seed patterns are generated for a particular entity. In embodiments, seed patterns include the name of the entity and at least one additional term. The name of an entity describes the entity with enough particularity that the entity may be identified and may include more than just the proper or full name of the entity. Names may include the entities name, slang for the entity, an abbreviation of the entities name, and common misspelling of the entities name. In one embodiment, an entity refers to a type of product in a product category. For example, the “Canon” brand of digital cameras is one entity in the “digital camera” product category, which includes many different types, or “entities,” such as the various model numbers of Canon digital cameras. As such, for the product category of Canon Digital Cameras, a list of entities may include the PowerShot G12, the PowerShot S90, the SX121S, the D10, and the SD4500.

User queries are used to generate seed patterns for particular entities, such as the “D10” entity of the Canon digital camera product category. For example, a user may enter “buy D10” into a query box on a search results webpage. This query, “buy D10,” indicates the user's intent to purchase a D10 digital camera. In other words, a user's intent with respect to a category of products, when entering “buy D10,” is to purchase the entity following the term “buy.” As such, the entered query “buy D10” may be generalized into a seed pattern for “buy DCEntity,” where “DCEntity” represents a “digital camera entity.” The seed pattern “buy DCEntity” may then be satisfied by user queries for “buy PowerShot G12,” “buy SD4500,” etc.

If it is determined that a majority of users that enter a user query in a search results webpage that satisfies the seed pattern “buy DCEntity” are highly likely to purchase a digital camera, then a relatively high intent-strength score may be assigned to the seed pattern. For example, if approximately 90% of users that enter a query conforming to the “buy DCEntity” seed pattern intend to purchase the digital camera entity indicated by the user's query, then an intent-strength score of 0.9 may be assigned to that particular seed pattern (on a scale of 0-1). Such a determination may be made using query log data that demonstrates the percentage of time that a particular user enters a query conforming to that seed pattern results in an eventual purchase (i.e. 90 out of 100 queries conforming to “buy DCEntity” ended in a digital camera purchase). Alternatively, the intent-strength score of 0.9 may be manually assigned to the “buy DCEntity” seed pattern based on a variety of factors.

In embodiments, when a user enters a query that conforms to a particular seed pattern, the user will be assigned the corresponding intent-strength score associated with the seed pattern. For example, when a user enters a query that conforms to the seed pattern “buy DCEntity,” the user may be assigned a corresponding intent-strength score of 0.9. Therefore, based on a user's query that conforms to the seed pattern “buy DCEntity,” a determination is made that the user's intent is to purchase a digital camera, and the strength of that intent is assigned an intent-strength score of 0.9.

Similar seed patterns may be generated that reflect the same intended action (purchasing) but at a different level of intent strength. For example, user queries such as “D10 price,” “D10 coupon” and “D10 reviews,” may all indicate that a user intends to purchase a Canon D10 digital camera. These additional queries may be generalized to corresponding seed patterns, such as “DCEntity price,” “DCEntity coupon,” and “DCEntity reviews,” respectively. However, if it is determined that such additional queries are not as likely to result in an eventual purchase of the D10 camera as the “buy D10” query, varying intent-strength scores may be assigned to these seed patterns. For example, an intent-strength score of 0.8 may be assigned to these additional seed patterns, as reflective of a user's intent to purchase that is slightly less strong than the purchasing intent associated with a query conforming to “buy DCEntity.” In one embodiment, having assigned an intent-strength score of 0.8 to the seed pattern “DCEntity coupon,” a user entering a query conforming to this seed pattern may be assigned a corresponding intent-strength score of 0.8, thus reflecting the user's level of intent to purchase a particular digital camera entity.

In addition to manually determining seed patterns and assigning intent-strength scores based on manually-identified user intent, random walk may be utilized to automatically expand the manually determined seed patterns and identify additional seed patterns and their corresponding intent-strength scores. For example, a number of query results are generated in response to user queries satisfying the seed pattern “buy DCEntity.” Using the previously-generated list of entities, the term “DCEntity” may be replaced with the names of entities in the digital camera product category, such as, for example, “buy D10,” “buy PowerShot G12,” “buy SD4500,” and the like. In one embodiment, because “buy DCEntity” was assigned the intent-strength score of 0.9, queries for “buy d10,” “buy PowerShot G12,” and “buy SD4500” are also assigned intent-strength scores of 0.9. This list of exemplary queries (“buy d10,” “buy PowerShot G12,” and “buy SD4500”) is matched against user queries in query log data to determine which websites were most likely to be selected when displayed as results in response to the corresponding user queries.

Random walk is further utilized to evaluate the query log data results of the exemplary queries. For example, query log data may demonstrate that, in response to 100 user queries for the phrase “buy D10,” a particular website “a.com” is selected 70% of the time. In other words, if a query for “buy D10” occurs 100 times in a search log, 70 out of those 100 times results in the user's selection of “a.com.” Because “buy D10” (and seed pattern “buy DCEntity”) has an assigned intent-strength score of 0.9, the same level of intent will be carried forward into the particular website selected in response to this query—namely, “a.com.” Therefore, multiplying 0.9 (intent-strength score) by 0.7 (likelihood of selecting “a.com”) provides a score that reflects the likelihood of a user buying a digital camera from the website “a.com.” In other words, 0.9×0.7=0.6 (rounding to nearest 10^{th}), where 0.6 reflects the likelihood of a user purchasing a D10 digital camera from “a.com.”

Intent-strength scores associated with a particular website may then be used to assign intent-strength scores to additional user queries. For example, the score of 0.6 may be used to determine the intent-strength scores for other user queries where a user selected the website “a.com.” For example, query log data may demonstrate that the user query “D10 discount” also resulted in a user's election of “a.com.” Specifically, “a.com” may be selected 90 out of 100 times that “D10 discount” was entered as a query. Having already associated 0.6 as an indicator of a user's likelihood of purchasing a camera from “a.com,” 0.6 may be divided by 0.9 (the likelihood of selecting “a.com”) to provide the intent-strength score of 0.7 for “D10 discount.” In other words, 0.7 reflects the strength of a user's intent to purchase a digital camera when entering the query “D10 discount.” Similarly, this 0.7 intent-strength score will be applied to the seed pattern for the same query, namely “DCEntity discount.”

In addition to manually determining seed patterns and intent-strength scores, as well as utilizing random walk to determine additional seed patterns and corresponding intent-strength scores, a machine-learned model may also be implemented to generate additional seed patterns and intent-strength scores. For example, the manually-determined seed patterns and automatically-determined seed patterns, along with their corresponding intent-strength scores, may provide training data for a machine-learned model to identify which features may lead to a positive result (which patterns lead to an intended action, such as a purchase) and which features lead to a negative result (which patterns don't lead to an intended action, such as a purchase). For example, the machine-learned program “learns” from the training data and determines which features of query log data are most likely to result in the particular action (i.e. the purchase of a product). From these features, the machine-learned model may identify additional seed patterns, as well as assign corresponding intent-strength scores to the seed patterns. In embodiments, the machine-learned model is used to “classify” and/or assign intent-strength scores to queries (and seed patterns) that are not already identified by the manual and automatic generation discussed above.

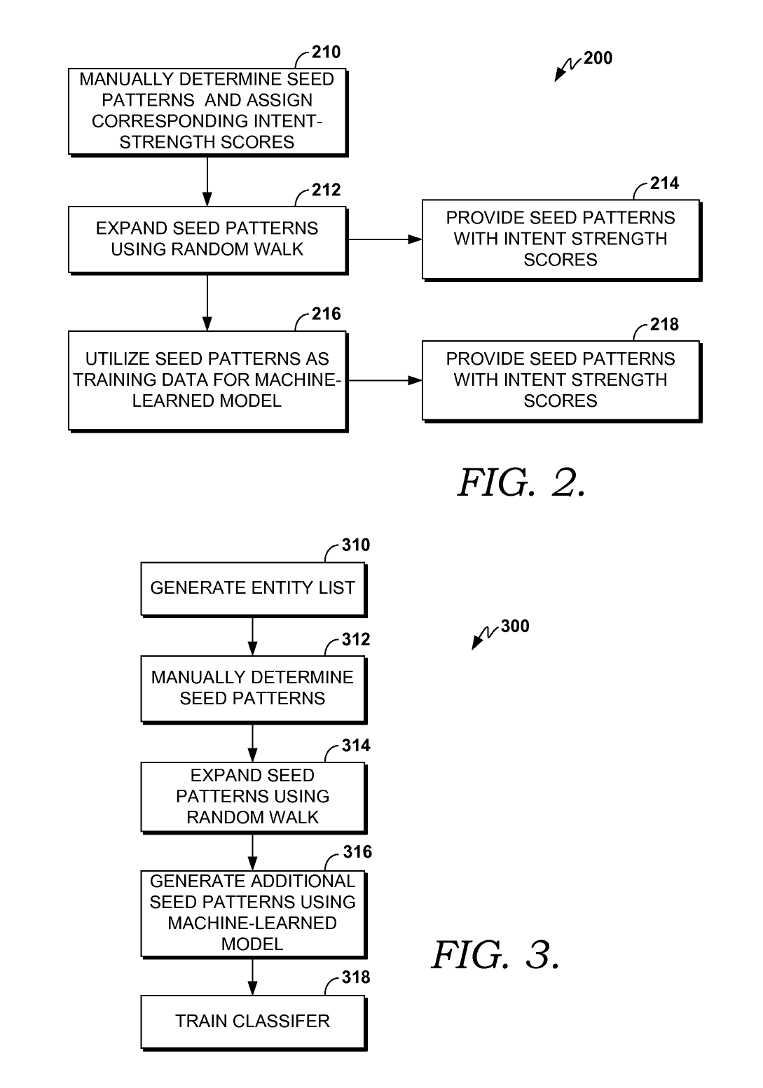

Referring now to FIG. 2, a flow diagram depicts a method 200 for training a classifier for intent-strength score detection, in accordance with embodiments of the present invention. As used herein, a classifier refers to a tool used to identify whether a user query indicates a certain level of intent strength with respect to a particular action. For example, a classifier may identify that a user query indicates a strong intent to purchase a particular product. In making such a determination, a classifier is “trained” to compare user queries to existing data, including seed patterns with corresponding intent-strength scores. The seed patterns utilized by a classifier may be derived, as discussed above, from manual seed-pattern determination, automatic seed-pattern determination using random walk, automatic seed pattern determination using a machine-learned model, or a combination of some or all of these sources.

At block 210, seed patterns are manually determined and assigned corresponding intent-strength scores. For example, the seed pattern “buy DCEntity” may be assigned an intent-strength score of 0.9. At block 212, seed patterns are expanded using random walk. As discussed above, random walk may be utilized to determine additional seed patterns based on the already-determined seed patterns. Random walk may also be utilized to assign intent-strength scores to the corresponding expanded seed patterns. As a result of the random walk carried out at block 212, seed patterns are provided at block 214 with corresponding intent-strength scores. In embodiments, the seed patterns of block 214 include both the manually determined seed patterns of block 210 and the expanded seed patterns of block 212. The intent-strength scores at block 214 may be utilized to train a classifier for intent-strength score detection.

At block 216, the manually-determined seed patterns and expanded seed patterns are utilized as training data for a machine-learned model. As discussed above, the machine-learned model may be used to generate seed patterns not previously identified during manual seed pattern determination (block 210) or expanded seed pattern determination using random walk (block 212). At block 218, seed patterns with corresponding intent-strength scores are provided for training a classifier for intent-strength score detection.

Turning next to FIG. 3, a flow diagram depicts a method 300 for training a classifier for intent-strength score detection, in accordance with embodiments of the present invention. At block 310, an entity list is generated. A list of entities refers to a list of the products in a product category, such as, for example, the brand or model names of a particular product. In one embodiment, an entity list is generated by locating a website that provides a listing of entities for a particular product. For example, a website may provide a list of all the different brand names and/or model numbers of digital cameras. In another embodiment, a list of entities may be automatically generated by crawling a number of websites to collect a raw entity list. Such a raw listing of entities may be cleaned and filtered using query log data. For example, a crawled website may provide the model number of “Canon d90” as one type of digital camera entity. However, when verifying the entity “Canon d90” using query log data, it may be determined that very few user queries are present in the log data for the term “Canon d90.” Therefore, the entity “Canon d90” may be omitted from the entity list. Alternatively, a crawled website may indicate that another entity of digital camera is a “Canon 5d,” and the query log data may verify that, when utilized as the term in a user query, users frequently click on a webpage related to digital cameras. As such, the entity “Canon 5d” may be determined to be a relevant entity, and may be included in the digital camera entity list.

Having identified one or more entities on a list of entities, either by extracting from a website listing of entities or by crawling websites and validating entity types using query log data, one or more entities in the list may be used to expand the list of entities. For example, having identified “Canon 5d” as a relevant entity of digital camera, the entity may be used to further expand the entity list for digital cameras. This may be done utilizing query log data to evaluate the webpages clicked on in response to a query including the term “Canon 5d.” As such, similar user queries where a user clicked on the same webpage results are determined to potentially behave similarly to the same entity as the “Canon 5d” query. For example, a query including the terms “d9 camera” may generate the same webpage results as those generated for the “Canon 5d” query. If users select the same webpage in response to both queries, then “d9 camera” may be associated as another entity of digital camera.

At block 312, seed patterns are manually determined. At block 314, the seed patterns of block 312 are used during random walk to generate an expanded list of seed patterns. At block 316, the seed patterns of one or both of blocks 312 and 314 are utilized as training data to generate additional seed patterns using a machine-learned model. At block 318, a classifier is trained for intent-strength score detection.

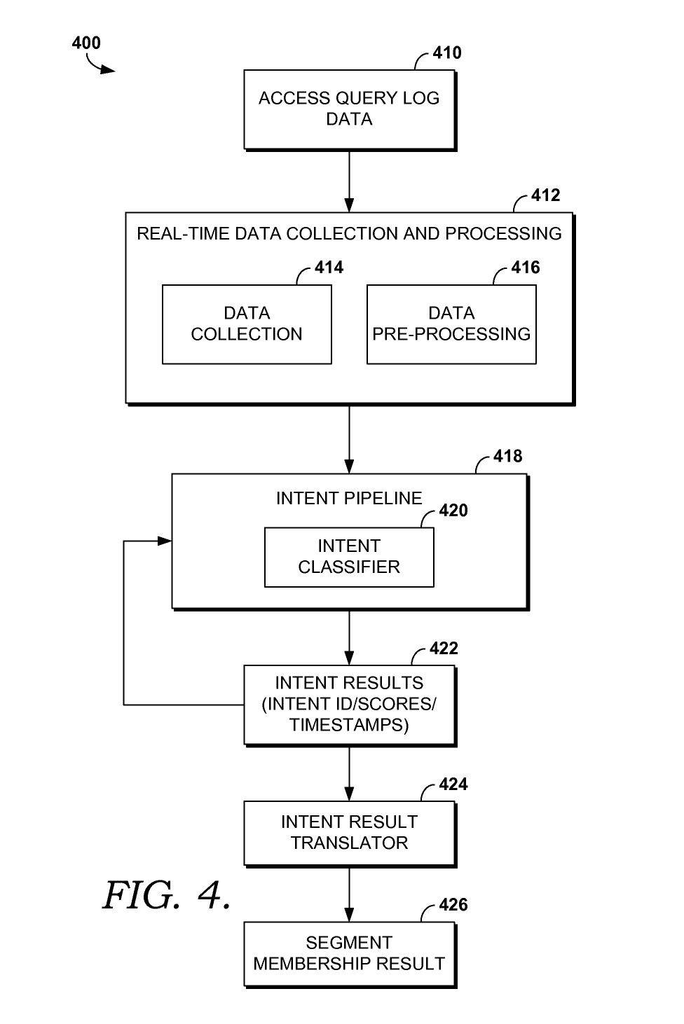

With reference now to FIG. 4, a flow diagram depicts a method 400 for online intent detection and intent-score result generation, in accordance with an embodiment of the present invention. Online intent detection refers to the real-time and/or live determination of a level of user intent with respect to a particular entity, based on intent-strength score detection. In embodiments, such level of intent may represent a user's intent to purchase a particular good, such as the purchase of a digital camera. In other embodiments, online intent detection may reflect a user's interest in selling a particular product. Although primarily referred to with respect to purchasing intent, it should be understood that online intent detection may determine a particular user's level of intent with respect to any number of actions related to an entity. For example, for a list of entities of colleges, a user's intent to enroll in college may be detected, based on queries entered by the user and intent-strength scores assigned to the user based on such queries. As such, an intent may reflect a user's general interest or intended behavior with respect to any content being viewed on a webpage.

At block 410, query log data is accessed. The accessed query log data may include a user's queries entered into the query box on a search results webpage, such as one or more queries entered into the search box on www.bing.com. In embodiments, query log data is accessed throughout method 400, and is not limited to being accessed at only one timepoint in the flow of online intent detection. Real-time data collection and processing takes place at block 412. Two subcomponents of block 412 include data collection at block 414 and data pre-processing at block 416. At block 414, data collection includes the collection of raw data from a user query, including the user query, a user ID, a machine type, a browser type, etc. At block 416, the raw data of block 414 is pre-processed to “clean” the data and determine relevant pieces of information, including, for example, a particular user query and the user ID associated with that query.

A collected and processed user query from block 412 is delivered into the intent pipeline of block 418. Intent pipeline 418 includes an intent classifier 420. The training of an intent classifier, as previously discussed, includes providing the classifier with seed patterns and corresponding intent scores. Intent classifier 420 is used as part of the intent pipeline 418 to determine a user's intent based on intent-strength scores. In embodiments, the intent classifier 420 evaluates the user query delivered from block 412, by comparing the query against an entity list and matching the query against the seed pattern list for that particular entity. For example, a user query for “buy D10” is compared against the entity list of digital cameras that includes “D10” as an entity, and therefore compared against the seed pattern “buy DCEntity.” As previously discussed, by correlating the user query of “buy D10” with the seed pattern of “buy DCEntity,” having an intent-strength score of 0.9, the intent classifier 420 may then assign an intent-strength score of 0.9 to the user for the action “purchase” within the “digital camera” product category.

At block 422, intent results are processed. In one embodiment, intent results include an intent ID, an intent-strength score, and a timestamp. For example, for the digital camera entity (intent ID) a user may have a score of 0.9 (derived from a query satisfying seed pattern for “buy DCEntity”) that was established at a particular time (the current date/time when the user entered the query “buy D10”). In one embodiment, the intent results of block 422 may be updated by returning to the intent pipeline 418. For example, a user may enter a different user query at a later time that indicates a new intent with respect to a particular intent ID. In other words, the user may initially be assigned an intent-strength score of 0.9, having entered a query for “buy D10,” but at a later time, enter the query “D10 discount,” having an intent-strength score of 0.7. As the user's intent with respect to the digital camera entity has changed, the intent result may be updated based on a newly assigned intent-strength score by the intent classifier 420.

Intent results processed at block 422 may also be updated and/or changed according to a function. In embodiments, changing a corresponding intent-strength score according to a function includes varying the function according to one or more variables. The one or more variables may include such factors as time, product characteristics, user characteristics, and the like. In one embodiment, an intent-strength score may be changed at block 422 according to a function that varies with time, such as a linear decay function that goes to zero or an exponential decay function that approaches zero. For example, a user's intent-strength score may start at 0.9, but may linearly decrease 1/10 each day so that after 10 days, the intent-strength score is eliminated. In another embodiment, intent-strength scores may change according to a function that declines very slowly at first, and then declines very quickly. Such a function may be used with respect to intent-strength scores for an entity that initially peaks a user's interest, but then the user's relative level of purchasing intent decreases dramatically.

Varying a function according to product characteristics refers to varying the change in an intent-strength score based on the type of product and/or product category. For example, an intent-strength score may be changed according to a different function based on whether the user intends to purchase a digital camera as compared to whether the user intends to purchase a house. As such, with respect to intent-strength scores for purchasing a digital camera, the score may be decreased over a period of 10 days if it is determined that the purchase of a digital camera is a minimal investment that will likely take place within 10 days of the initial association of a user with an intent-strength score for such a purchase. Conversely, the intent-strength score for purchasing a home may be assigned a corresponding intent-strength decay function that allows the score to remain active for a period of 60 days, as the purchase of a home is not likely to be reflected in a mere fleeting purchasing intent. In further embodiments, a function may be used that varies an intent-strength score in accordance with such product characteristics as changes in the product's price, whether or not the product is perishable, and whether the product is only offered during particular seasons of the year. As such, the function utilized to change intent-strength scores may vary depending on the type of entity.

Varying a function according to user characteristics may reflect a variety of factors that affect a particular user or group of user's intent strengths. For example, intent-strength scores for users in a particular age bracket may decrease at a different rate than intent-strength scores for users in a different age bracket. In another embodiment, a function may vary according to user habits, as reflected in query log data. For example, if a particular user typically purchases electronic goods within five days of initially expressing interest in such a purchase (i.e. within five days of entering a query conforming to a seed pattern that indicates intent to purchase), the user's intent-strength score may be decreased according to a function over a five-day period.

The intent results generated at block 422 are then provided to an intent result translator at block 424. The intent result translator utilizes the intent ID's and intent-strength scores to generate a list of users that satisfy particular requirements. For example, an advertiser may request a list of all the users with intent-strength scores of 0.9 for the digital camera entity. The intent result translator generates results for such a request, and filters the intent results of block 422 to determine a final list of users to deliver to the advertiser. In other words, the intent result translator “translates” a list of users based on intent-strength scores. At block 426, the translated list of users is communicated and/or output to the advertiser. As such, the group of users belonging to the requested segment of users is provided as a result of the online intent detection of method 400.

In one embodiment, an advertiser seeking to present action-aware intent-based behavior-targeted advertisements to a user or group of users may request the user ID's of a set of users having particular intent-strength scores for a particular entity. With such a listing, the advertiser is able to solicit users that have demonstrated an intent with respect to a particular product and a particular action. For example, the advertiser may request the ID's of users with a strong intent to purchase a digital camera. In embodiments where intent-strength scores are updated based on subsequent user queries, the advertiser is provided with an up-to-date listing of users currently having the requested intent strength.

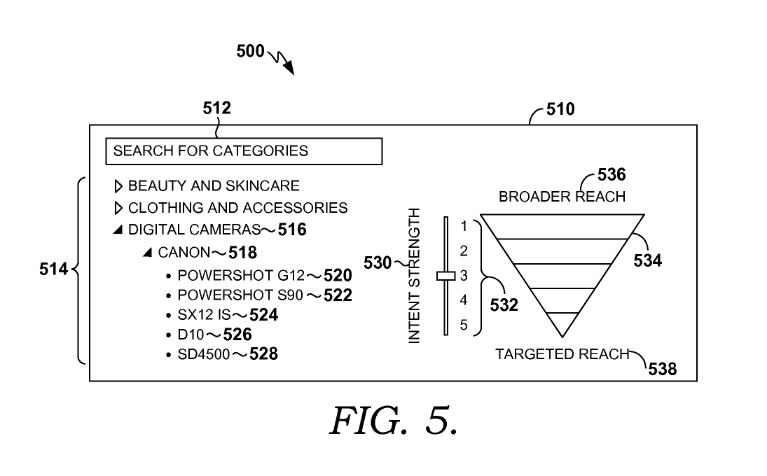

Referring finally to FIG. 5, an exemplary user interface 500 for selecting a group of users based on intent-strength scores is shown. The display 510 includes a category search box 512 and a category-listing area 514. As part of the category-listing area 514, a number of product categories are displayed, including digital camera product category 516. An entity of product category 516 is displayed as the Canon entity 518. Included in the Canon entity 518 is a list of exemplary Canon digital camera entities, including the Powershot G12 520, the Powershot S90 522, the SX12 IS 524, the D10 526, and the SD4500 528. In embodiments, the category-listing area 514 may include any number of categories, while the list of entities may include any number of entities.

Display 510 also includes an intent-strength selector 530, with values ranging from 1-5 on the intent-strength meter 532. Intent-strength funnel 534 represents the range of intent strengths represented by the values selected on the intent-strength selector 530. For example, the top of the intent-strength funnel 534 is directed to a broader reach 536, which is associated with more users that have a weakened intent strength (approaching 1). Conversely, the bottom of the intent-strength funnel 534 is directed to a targeted reach 538, which is associated with fewer users that have a stronger intent strength (approaching 5). As will be understood, the intent-strength selector 530 may represent any number of values of intent-strength scores on the intent-strength meter 532, and is not limited to values ranging between 1-5.

Based on a user's selection of an entity from category-listing area 514, and further selection of a desired intent strength from the intent-strength selector 530, a listing of users having the desired intent-strength scores is generated and provided to the user of the display 510. When display 510 is accessed by a user, such as a potential advertiser, the user may select an intended product category from the category-listing area 514. In one embodiment, the user may search for a particular category in the category search box 512. Based on the generated list of potential product categories, the user may then select the intended entity for further intent-strength selection using the display 510. For example, an advertiser may be interested in selecting all the users with a particular intent-strength score related to the entity Canon 518. Having selected Canon 518, the user may then manipulate the intent-strength selector 530 by adjusting the slide bar of the selector between the ranges of designated strengths. If the advertiser is interested in marketing to users with a strong intent to purchase Canon digital cameras, then the advertiser will move the intent-strength selector 530 in the direction of the “5” value of the intent-strength meter 532. The users associated with this intent strength will have strong intent-strength scores, and therefore provide the advertiser with a more targeted reach to a fewer number of consumers. By contrast, selecting users with a value in the direction of “1” on the intent-strength meter 532 will generate a list of users that have weaker intent-strength scores, but a broader range of users. As such, an advertiser can either select a broader reach (larger group) of users with a weaker intent strength, or a more targeted reach (smaller group) of users with stronger intent-strength scores.

The present invention has been described in relation to particular embodiments, which are intended in all respects to be illustrative rather than restrictive.

It will be understood that certain features and subcombinations are of utility and may be employed without reference to other features and subcombinations.

What is claimed is:

1. One or more computer-readable media storing computer-usable instructions that, when used by one or more computing devices, causes the one or more computing devices to perform a method for classifying user intent with respect to at least one entity, the method comprising:
identifying one or more seed patterns for the at least one entity, wherein the one or more seed patterns comprise one or more terms and a name for the at least one entity;
expanding the one or more identified seed patterns using query log data to identify one or more additional seed patterns for the at least one entity; and
assigning intent-strength scores to the one or more identified seed patterns and the one or more additional seed patterns, wherein the intent-strength scores identify a level of user interest with respect to the at least one entity.

2. The one or more computer-readable media of claim 1, wherein the method further comprises:
assigning a corresponding intent-strength score with each of one or more users, the intent-strength score indicating each of the one or more user's classified user intent, wherein the corresponding intent-strength score is based on one or more user queries entered by each of the one or more users and the intent strength-scores assigned to the one or more identified seed patterns and the one or more additional seed patterns.

3. The one or more computer-readable media of claim 2, wherein associating a corresponding intent-strength score with each of one or more users comprises:
updating the corresponding intent-strength score assigned to each of the one or more users based on one or more subsequent queries entered by the one or more users and the intent-strength scores assigned to the one or more identified seed patterns and the one or more additional seed patterns.

4. The one or more computer-readable media of claim 2, wherein associating a corresponding intent-strength score with each of one or more users comprises:
changing the corresponding intent-strength score according to a function, wherein the function varies according to one or more variables, the one or more variables comprising time, product characteristics, and user characteristics.

5. The one or more computer-readable media of claim 2, wherein the method further comprises:
presenting at least one behavior-targeted display advertisement to the one or more users, the behavior-targeted display advertisement associated with the entity, wherein said presenting is based on each of the one or more user's classified user intent with respect to the entity.

6. The one or more computer-readable media of claim 5, wherein the method further comprises:
receiving an indication that at least one of the one or more users is accessing an internet browser of a computing device; and
presenting the at least one behavior-targeted display advertisement to the at least one of the one or more users using the internet browser.

7. The one or more computer-readable media of claim 6, wherein receiving an indication that the at least one of the one or more users is accessing an internet browser of a computing device comprises one or more of monitoring the at least one user's user ID and monitoring the at least one user's machine ID.

8. The one or more computer-readable media of claim 1, wherein identifying one or more seed patterns for at least one entity comprises manually defining one or more seed patterns for the at least one entity.

9. The one or more computer-readable media of claim 1, wherein expanding the one or more identified seed patterns using query log data from one or more users comprises utilizing random walk to expand the one or more identified seed patterns.

10. The one or more computer-readable media of claim 1, wherein assigning intent-strength scores to the one or more identified seed patterns and the additional one or more seed patterns comprises:
utilizing a machine-learning model to associate intent-strength scores with one or more of the one or more identified seed patterns and the one or more additional seed patterns.

11. One or more computer-readable media storing computer-usable instructions that, when used by one or more computing devices, causes the one or more computing devices to perform a method for classifying user intent with respect to at least one entity, the method comprising:
assigning intent-strength scores to each of one or more seed patterns, wherein the one or more seed patterns were identified for the at least one entity, wherein an intent-strength score describes a user's level of interest related to the at least one entity; and
assigning corresponding intent-strength scores to each of a first set of one or more users by correlating on one or more queries entered by the first set of one or more users with the intent-strength scores assigned to the one or more seed patterns.

12. The one or more computer-readable media of claim 11, wherein the method further comprises:
generating a user interface for selecting a group of users from the first set of one or more users for presenting behavior-targeted advertisements to, the selected group of users having particular corresponding intent-strength scores, the user interface comprising:
(1) a first display area for receiving an indication of a category selection, the category selection indicating a type of entity; and
(2) a second display area for receiving an indication of a desired level of user intent related to the selected category, wherein the level of user intent is specified with intent-strength scores.

13. The one or more computer-readable media of claim 11, wherein assigning intent-strength scores to each of one or more seed patterns comprises:
expanding the one or more identified seed patterns to identify one or more additional seed patterns using query log data from a second set of one or more users; and
assigning intent-strength scores to each of the one or more additional seed patterns.

14. The one or more computer-readable media of claim 11, wherein assigning corresponding intent-strength scores to a first set of one or more users further comprises:
updating the corresponding intent-strength scores assigned to the first set of one or more users based on one or more subsequent queries entered by the first set of one or more users and the intent-strength scores assigned to the one or more seed patterns.

15. The one or more computer-readable media of claim 11, wherein assigning corresponding intent-strength scores to a first set of one or more users further comprises:
changing the corresponding intent-strength scores according to a function, wherein the function varies according to one or more variables, the one or more variables comprising time, product characteristics, and user characteristics.

16. One or more computer-readable media storing computer-usable instructions that, when used by one or more computing devices, causes the one or more computing devices to perform a method for determining a user's classified user intent with respect to at least one entity, the method comprising:
receiving an indication of a user query submitted by the user; and
classifying the user's intent with respect to the at least one entity, the classified user intent having an assigned intent-strength score, wherein the user's assigned intent-strength score is determined according to the following:
(1) assigning intent-strength scores to each of one or more seed patterns, wherein the one or more seed patterns were identified for the at least one entity; and
(2) assigning a corresponding intent-strength score to the user that indicates the user's classified user intent, wherein the corresponding intent-strength score is based on the indication of a user query submitted by the user and the intent-strength scores assigned to each of the one or more seed patterns.

17. The one or more computer-readable media of claim 15, wherein the method further comprises:
presenting at least one behavior-targeted display advertisement to the user, the at least one behavior-targeted display advertisement based on the user's classified user intent.

18. The one or more computer-readable media of claim 15, wherein assigning intent-strength scores to each of one or more seed patterns comprises:
expanding the one or more identified seed patterns to identify one or more additional seed patterns using query log data from a plurality of users; and
assigning intent-strength scores to the one or more identified seed patterns and the one or more additional seed patterns.

19. The one or more computer-readable media of claim 15, wherein the method further comprises:
updating the user's classified intent with respect to the at least one entity based on one or more subsequent indications of user queries submitted by the user and the intent-strength scores assigned to the one or more seed patterns.

20. The one or more computer-readable media of claim 15, wherein classifying the user's intent with respect to the at least one entity comprises:
changing the corresponding intent-strength score assigned to the user according to a function, wherein the function varies according to one or more variables, the one or more variables comprising time, product characteristics, and user characteristics; and
updating the user's intent with respect to the at least one entity based on changing the corresponding intent-strength score according to the function.
